(19) United States
(12) Patent Application Publication
(10) Pub. No.: US 2009/0095005 A1
(43) Pub. Date: Apr. 16, 2009

(54) Air-Conditioning System

(76) Inventors: Gunnar Dietrich, Mannheim (DE); Michael Sonnekalb, Schwalmstadt (DE)

Correspondence Address: DEERE & COMPANY, ONE JOHN DEERE PLACE, MOLINE, IL, 61265, US

(21) Appl. No.: 12/293,325

(22) PCT Filed: Mar. 16, 2007
(86) PCT No.: PCT/EP07/52546

§ 371 Date: Sep. 17, 2008

(30) Foreign Application Priority Data
Mar. 17, 2006 (DE) 10 2006 012 709.9
May 27, 2006 (DE) 10 2006 024 796.5

(51) Int. Cl. B60H 1/32; F25B 1/00; F25B 27/00; F25B 7/00

(52) U.S. Cl. 62/244; 62/498; 62/335; 62/238.1

(57) ABSTRACT

Described is an air conditioning system with a heating function, wherein the inner heat exchanger is split in the air flow direction, wherein the first partial heat exchanger of the inner heat exchanger in the air flow direction preferably operates to cool the supply air, that is to say as a refrigerant evaporator, and wherein the second partial heat exchanger, which is connected downstream in the air direction, preferably operates to heat the supply air, that is to say as a refrigerant gas cooler, wherein the two partial heat exchangers of the inner heat exchanger can also both be used, in the case of the maximum cooling demand, as a refrigerant evaporator for cooling or can also both be used, in the case of the maximum heating demand, as refrigerant gas coolers for heating the supply air, and wherein in drying operation (reheat), the first partial heat exchanger of the inner heat exchanger in the air flow direction operates as a refrigerant evaporator and at the same time the second partial heat exchanger operates as a refrigerant gas cooler, as a result of which, in an advantageous manner in energy terms, the condensation heat of the air humidity is used, in addition to the compressor waste heat, for heating the supply air.

The invention relates to an air-conditioning system, in particular, for a vehicle, which can be used in different operating modes for cooling, dehumidifying, and heating the supply air for the inferior space.

In common, known air-conditioning systems for motor vehicles, the reheating mode designed for dehumidifying the supply air is realized in such a way that the supply air flows first to the evaporator of the air-conditioning system and then to the heating-system heat exchanger. In the heating-system, heat exchanger, the supply air is heated by the boat carrier fluid of the engine cooling circuit. This circuit is naturally provided only in motor vehicles with water-cooled internal combustion engines.

DE 10203293A1 discloses an air-conditioning system, which has a divided heat exchanger and which heats with hot gas. The evaporator, however, is spatially separated from the heater and the heater has its own expansion valve.

DE 10036038A1 shows an air-conditioning system with a heating function. On the air side, an additional heat exchanger is connected after the evaporator. This additional heat exchanger can be connected as a heater or as an evaporator. For small loads, no refrigerant at all flows through the additional heat exchanger. For a small cooling demand, refrigerant flows only through the condenser (outside) and the evaporator (inside) with the expansion valve. For an increased cooling demand, the additional heat exchanger is also connected after the evaporator. In beating mode, refrigerant does not flow through the evaporator (inside) and the condenser (outside). The additional heat exchanger beats with compressor heat or heat is drawn from the surroundings by means of an additional evaporator (outside) with the expansion valve.

In EP 0945290B1 or DE 19313673, an air-conditioning system with a heating function is described, which is set for heating in the heat-pump mode. It has no separate inner heat exchangers and also a reheating or dehumidifying mode is not described.

DE 10149187A1 describes an air-conditioning system with a heating function, which is set for heating in the heat-pump mode, whose heating heat exchangers and evaporators for the interior supply air are spatially separated, and also a reheating or dehumidifying mode by itself with the air-conditioning system is not possible.

In DE 10334907A1, an air-conditioning system is described, which has a heating function and which heats with hot gas. The inner heat exchanger is not separated, and a reheating or dehumidifying mode by itself with the air-conditioning system is not possible.

The invention is based on the problem of heating the supply air for the interior of the motor vehicle directly after the engine is started, so that the vehicle windows are free from ice and condensation as quickly as possible.

This problem is solved according to the invention by the features of Claim 1, Claim 2, and Claim 4. Preferred constructions or refinements of the invention are specified in the subordinate claims.

The air-conditioning system according to the invention, in particular, for a vehicle, can be switched by means of switching elements from the “cooling” operating mode to the “heating” operating mode wherein heating is also performed with the compressor. Through the configuration of the inner heat exchanger divided in the airflow direction, dehumidification of the supply air for the interior can also be achieved. Here, the supply air first flows through the first partial heat exchanger used advantageously as an evaporator and is in this way cooled, so that air moisture condenses on the heat-exchanging surface (plate). In the second partial heat exchanger used advantageously as a gas cooler, the supply air is then heated (reheating). This inner heat exchanger, which is used as a component of the refrigerant circuit in the supply airflow of the vehicle interior, can be divided according to the invention on the refrigerant side into a hot and a cold partial heat exchanger, and the air-side heat-exchanging surfaces of these two partial heat exchangers are thermally separated.

In particular, for consumption-optimized internal combustion engines, there is not enough waste heat in the cooling circuit of the engine during the cold-start phase. The air-conditioning compressor driven by the internal combustion engine delivers sufficient compressor waste heat for high compressor outlet temperatures immediately after starting. Through the direct beat transfer according to the invention in the inner heat exchanger acting as a gas cooler, exceptionally high supply air blow temperatures can be achieved, with which the windows can be blown free of ice and condensation immediately after starting. For this three-point process, the refrigerant runs through the compressor, through the inner heat exchanger, which works as a gas cooler, and possibly through an expansion element, which can be arranged either before or after the gas cooler.

For maximum heating output or for maximum cooling output, the two sub-branches of the inner heat exchanger can be connected in parallel. For the direct switching from maximum cooling to maximum heating, the windows could become clouded immediately through so-called “flash fogging.” The reasons for this lies in that the air moisture condensed out on the previously cooled beat-exchanging surface of the evaporator can evaporate immediately in the function as a gas cooler and condenses on the cold window. To avoid this, the first sub-branch of the inner heat exchanger in the airflow direction can also be operated without the second sub-branch in the “normal cooling” mode as an evaporator. This is advantageously the case shortly before reaching the desired interior temperature. Likewise, the second sub-branch of the inner heat exchanger in the airflow direction can also be operated without the first sub-branch in the “normal heating” mode as a gas cooler. The heat-exchanging surfaces of both sub-branches of the inner heat exchanger are thermally separated from each other by an air gap. For the “normal heating” mode, this prevents heat from being transferred from the second partial heat exchanger operated as a gas cooler to the first partial heat exchanger operated before as an evaporator, and any condensed air moisture can again be evaporated, A similar configuration is known from conventional vehicle air-conditioning systems, wherein, however, the cooling liquid of the engine is used as a heating medium. In addition, the supply air in the “dehumidifying and cooling” or “dehumidifying and heating” modes can be dehumidified by the reheating already described above, which counteracts the condensation on the windows.

Typically, for quickly cooling a vehicle interior greatly heated in the summer, the air-conditioning system according to the invention is operated first in the “maximum cooling” mode, in which both sub-branches of the inner heat exchanger operate as evaporators (cool down). Shortly before reaching the desired temperature, the system is switched to the “normal cooling” mode, in which only the first sub-branch (without the second sub-branch) of the inner heat exchanger operates as an evaporator, When the desired temperature is reached, the temperature is regulated, e.g., through targeted counter-heating with the second sub-branch of the inner heat exchanger as a gas cooler.

In this way, the second sub-branch heats up. Therefore, the supply air is dehumidified. Any residual humidity in this partial heat exchanger operated as an evaporator in the “maximum cooling” mode can indeed evaporate, but cannot condense on the windows, because in the summer, due to the outside air and possibly solar irradiation, the windows are warmer than the cooled supply air.

In contrast to reheating with engine cooling water, the air-conditioning system operation according to the invention in the “dehumidifying and cooling” mode is more efficient. The temperature level in the second sub-branch of the inner heat exchanger also operated as a gas cooler or condenser is significantly lower than, the temperature level in the outer heat exchanger. Therefore, the high pressure of the air-conditioning system can be reduced. The lower pressure difference and the lower pressure ratio advantageously affect the compressor efficiency. According to the invention, less compression work is required, because the difference in enthalpy between the compressor outlet and inlet decreases. This advantageously also causes a lower mechanical and thermal loading of the compressor. Through the reduction of the refrigerant inlet temperature according to the invention into the expansion element, the difference in enthalpy between the evaporator outlet and the evaporator inlet is advantageously increased. The air-conditioning system efficiency (CO) as a ratio of the evaporator power or evaporator enthalpy difference to the compressor operation or compressor enthalpy difference, respectively, increases.

Typically, the air-conditioning system with a heating function is operated according to the invention first in the “maximum heating” mode for quickly heating the vehicle interior that has greatly cooled down in a very cold winter. In this mode, both sub-branches of the inner heat exchanger work as gas coolers. For a possible occurrence of “flash fogging,” the air-conditioning system with a heating function is switched to the “normal heating” mode, in which only the second sub-branch (without the first sub-branch) of the inner heat exchanger operates as a gas cooler, “Flash fogging” can occur when the air-conditioning system in the latter mode has cooled or dehumidified, which can occur in times of transition (fall or spring) and in mild winters. This state of the last operating mode can be stored, e.g., in the controller of the air-conditioning system.

The “maximum heating” and “normal heating” operating modes are so-called hot-gas or three-point processes, as described above. Also, the third, “dehumidifying and heating,” mode is not a heat-pump process according to the invention, although the refrigerant in the second sub-branch of the inner heat exchanger is cooled and evaporated in the first sub-branch. The supply air to the vehicle interior is used both as a heat source (in the first partial heat exchanger) and also as a heat sink (in the second partial heat exchanger). As in the two other heating modes, the compressor waste heat represents a large portion of the introduced heat quantity. Relative to the pure hot-gas cycle, the “dehumidifying and heating” operating mode according to the invention has the advantage of using the latent heat of the condensable supply air humidity in addition to the compressor waste heat. Another advantage of this operating mode is to quickly free the windows from ice and condensation due to the dehumidified and heated supply air. For possible icing of the first sub-branch of the inner heat exchanger operating as an evaporator, which is detected by means of icing protection (e.g., temperature sensor), it is advantageously switched to the “normal heating” operating mode. This is a hot-gas cycle, in which refrigerant does not flow through, the first sub-branch of the inner heat exchanger. When the first sub-branch is defrosted by the supply air containing a portion, of heated return air from the vehicle interior, the system can again be switched to the “dehumidifying and heating” mode.

When the engine cooling water temperature reaches a defined desired value, preferably a value greater than the supply air blowing temperature, or when the desired value of the interior air temperature is reached, the heated engine cooling water in the heating heat exchanger, which is advantageously after the inner heat-exchanger of the refrigerant circuit in the airflow direction, takes over the heating of the supply air. The compressor of the air-conditioning system is turned off or, for reheating, the air-conditioning system is switched to the “normal cooling” mode. The heat transfer here takes place via the outer heat exchanger to the outside air, which, in this case, is typically colder than the supply air. Heating of the vehicle with engine cooling water waste heat is more advantageous in terms of energy than continuously driving the refrigerant compressor for heating by the engine. On the other hand, during the cold-start phase of the engine, not enough of this waste heat is available, and it is more useful in terms of energy to drive the refrigerant compressor than to drive the dynamo (generator) and to heat electrically, e.g., with PTC, since the efficiency of converting mechanical drive energy into electrical energy is generally worse.

Additional details, features, and advantages emerge from the following description of the enclosed drawings.

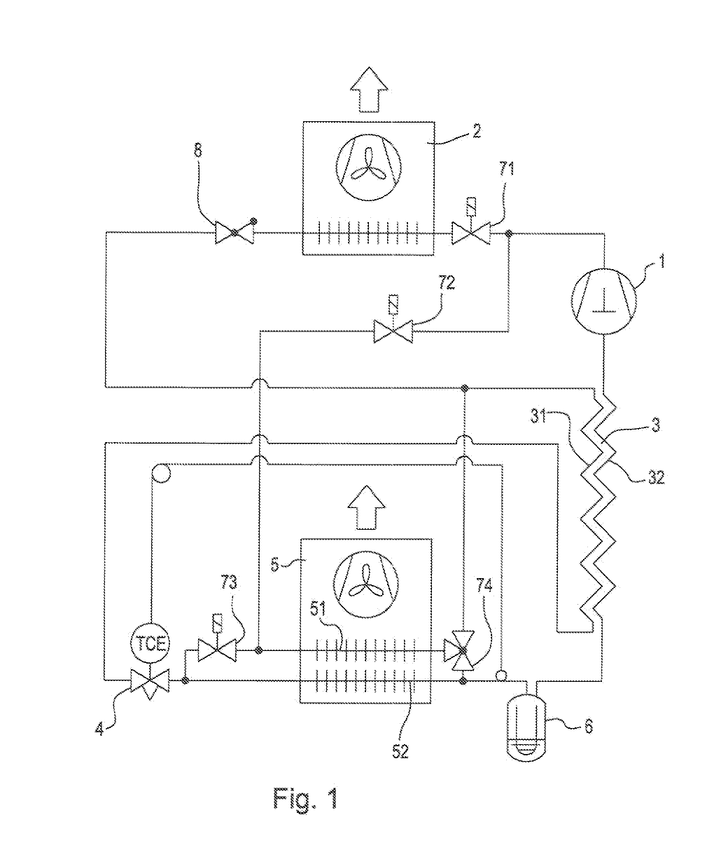

In FIG. 1, an air-conditioning heating system is shown, which can be operated in six modes by means of changeover valves 71, 72, 73, and 74. The inner heat exchanger 5 for the vehicle interior is divided in the airflow direction. The air first flows through the partial heat exchanger 52 advantageously used for cooling and then through the partial heat exchanger 51 advantageously used for heating. Behind this inner heat exchanger 5, in the airflow direction there can also be a heating heat exchanger, which heats the air by means of hot engine cooling water. The heat exchangers 2 and 5 and the changeover valves 71 to 74 are arranged in such a way that with as few valves as possible, the six operating modes can be realized. The partial heat exchangers 51 and 52 are each connected hi parallel in the “maximum cooling” and “maximum heating” operating modes. In the “normal cooling” and “normal heating” operating modes, refrigerant flows through only one partial heat exchanger. In the “dehumidifying” operating mode, refrigerant flows through the partial, heat exchanger 51 with high pressure and through the partial heat exchanger 52 with low pressure. The non-return valve 8, the inner heat exchanger 3, and the collector 6 are optional components.

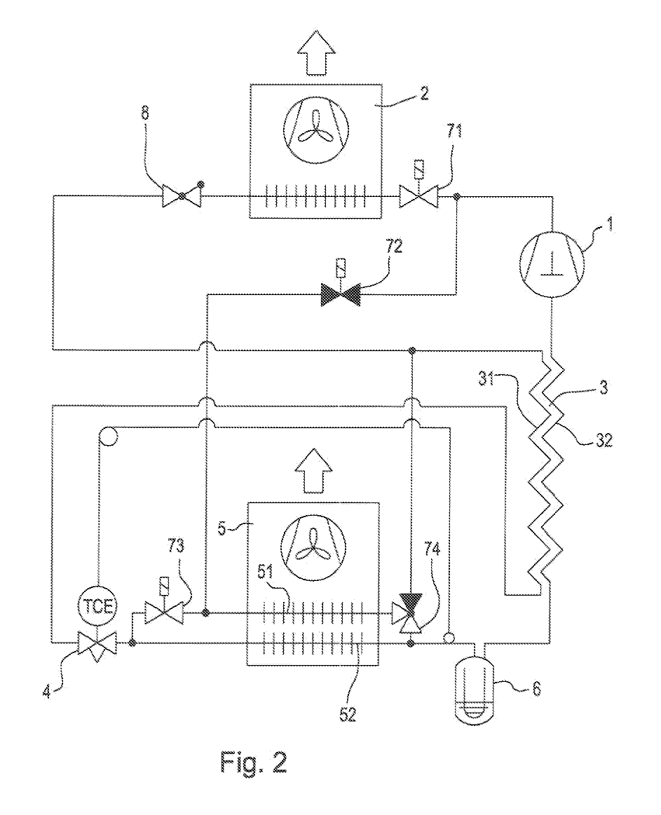

In FIG. 2, the “maximum, cooling” mode is shown. The refrigerant is compressed by the compressor 1 to high pressure and flows via the valve 71, the outer heat exchanger 2, the optional non-return valve 8, and the high-pressure part 31 of the inner heat exchanger 3 to the expansion element 4. In the expansion element 4, the refrigerant is reduced in pressure and flows via the inner heat exchanger 5, the collector 6, and the low-pressure part 32 of the inner heat exchanger 3 back to the compressor 1. The refrigerant here evaporates in the inner heat exchanger 5, wherein a part flows through the sub-branch 52 and another part flows in parallel through the valve 73, the sub-branch 51, and the three-way valve 74. The valve 72 remains closed in this operating mode.

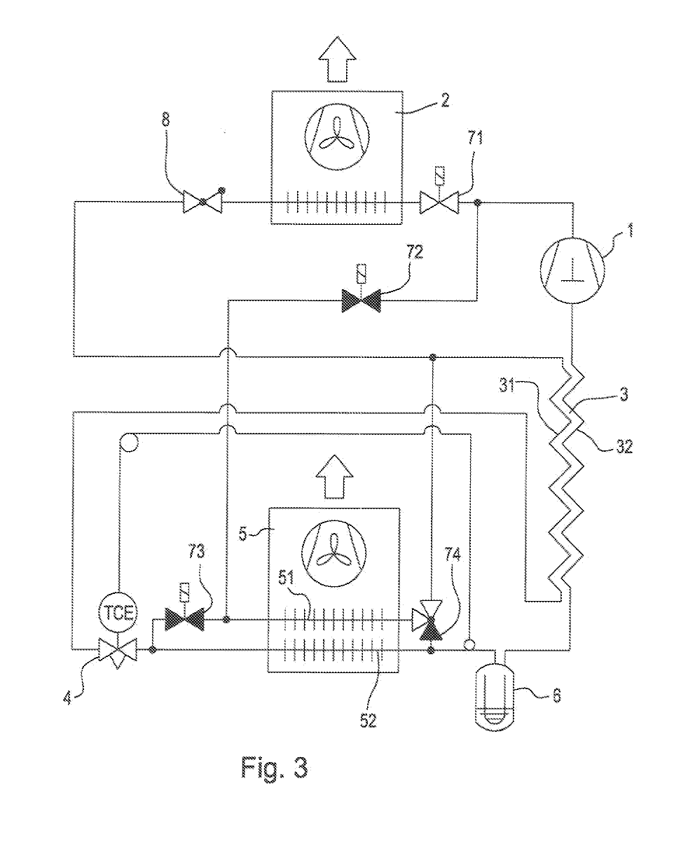

In FIG. 3, the “normal cooling” mode is shown. The refrigerant is compressed by the compressor 1 to high pressure and flows via the valve 71, the outer heat exchanger 2, the optional non-return valve 8, and the high-pressure part 31 of the inner heat exchanger 3 to the expansion element 4. In the expansion element 4, the refrigerant is reduced in pressure and flows via the inner heat exchanger 5, the collector 6, and the low-pressure part 32 of the inner heat exchanger 3 back to the compressor 1. The refrigerant here evaporates in the inner heat exchanger 5, wherein all of the refrigerant Sows only through the sub-branch 52. The valves 12 and 73 remain closed in this, operating mode and the three-way valve 74 blocks the sub-branch 51 of the inner heat exchanger 5 from the sub-branch 52.

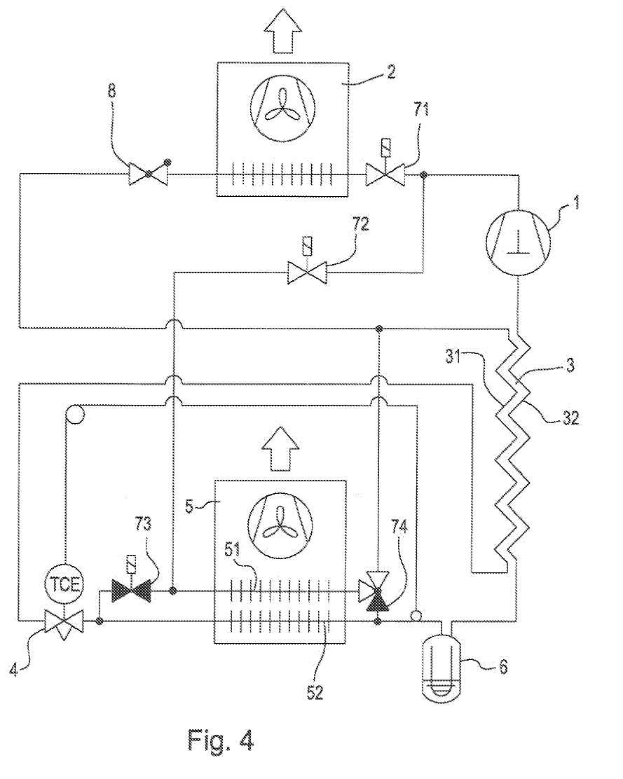

In FIG. 4, the “dehumidifying and cooling” mode is shown. The refrigerant is compressed by the compressor 1 to high pressure. A part of the refrigerant flows via the valve 71, the outer heat exchanger 2, and the optional non-return valve 8; another part flows in parallel via the valve 72, the sub-branch 51 of the inner heat exchanger 5, and the three-way valve 74 to the high-pressure part 31 of the inner heat exchanger 3 and further to the expansion element 4. In the expansion element 4, the refrigerant is reduced in pressure and flows via the sub-branch 52 of the inner heat exchanger 5, the collector 6, and the low-pressure part 32 of the inner heat exchanger 3 back to the compressor 1. The refrigerant here evaporates in the sub-branch 52 of the inner beat exchanger 5. The valve 73 and the three-way valve 74 block the sub-branch 51 of the inner heat exchanger 5 from the sub-branch 52. The air flowing through the inner heat exchanger 5 is first cooled by the partial heat exchanger 52 and in this way dehumidified and then reheated in the partial heat exchanger 51. The air discharge temperature of the inner heat exchanger 5 can be controlled via selective opening and closing of the valve 72.

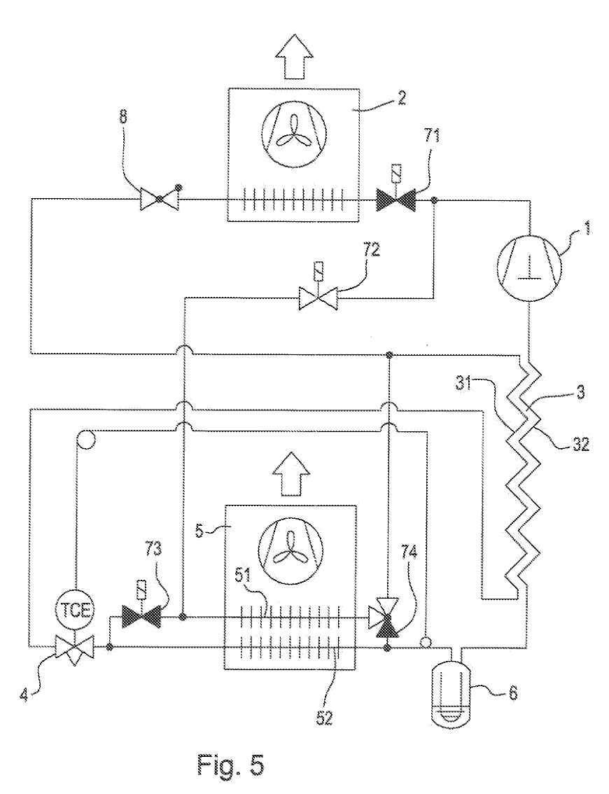

In FIG. 5, the “dehumidifying and heating” mode is shown. The refrigerant is compressed by the compressor 1 to high pressure and flows via the valve 72, the sub-branch 51 of the inner heat exchanger 5, and the three-way valve 74 and the high-pressure part 31 of the inner heat exchanger 3 to the expansion element 4. In the expansion element 4, the refrigerant is reduced in pressure and flows via the sub-branch 52 of the inner heat exchanger 5, the collector 6, and the low-pressure part 32 of the inner heat exchanger 3 back to the compressor 1. The refrigerant here evaporates in the sub-branch 52 of the inner heat exchanger 5. The valve 73 and the three-way valve 74 block the sub-branch 51 of the inner heat exchanger 5 from the sub-branch 52. The air flowing through the inner beat exchanger 5 is first cooled by the partial heat exchanger 52 and in this way dehumidified and then reheated in the partial heat exchanger 51. The air discharge temperature of the inner heat exchanger 5 can be regulated by means of selective opening and closing of the valve 71, wherein a part of the refrigerant flows in parallel to the sub-branch 51 of the inner heat exchanger 5 via the valve 71, the outer heat exchanger 2, and the optional non-return valve 8 to the high-pressure part 31 of the inner heat exchanger 3.

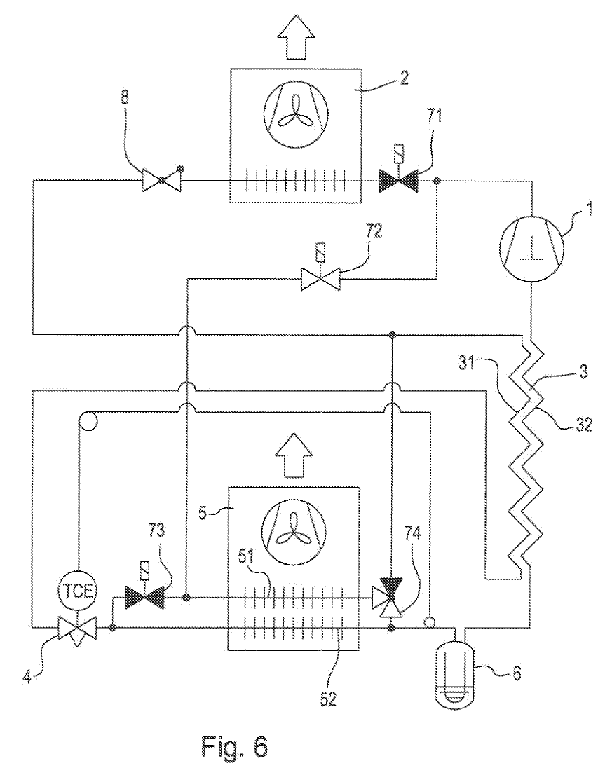

In FIG. 6, the “normal heating” mode is shown. The refrigerant is compressed by the compressor 1 to high pressure and flows via the valve 72, the sub-branch 51 of the inner heat exchanger 5, the three-way valve 74, the collector 6, and the low-pressure part 32 of the inner heat exchanger 3 back to the compressor 1. The valves 71 and 73 remain closed in this operating mode. A flow does not pass through the outer heat exchanger 2, the high-pressure part 31 of the inner heat exchanger 3, and the sub-branch 52 of the inner heat exchanger 5. The refrigerant can expand from high pressure to low pressure, e.g., through the pulsed opening and closing of the valve 72.

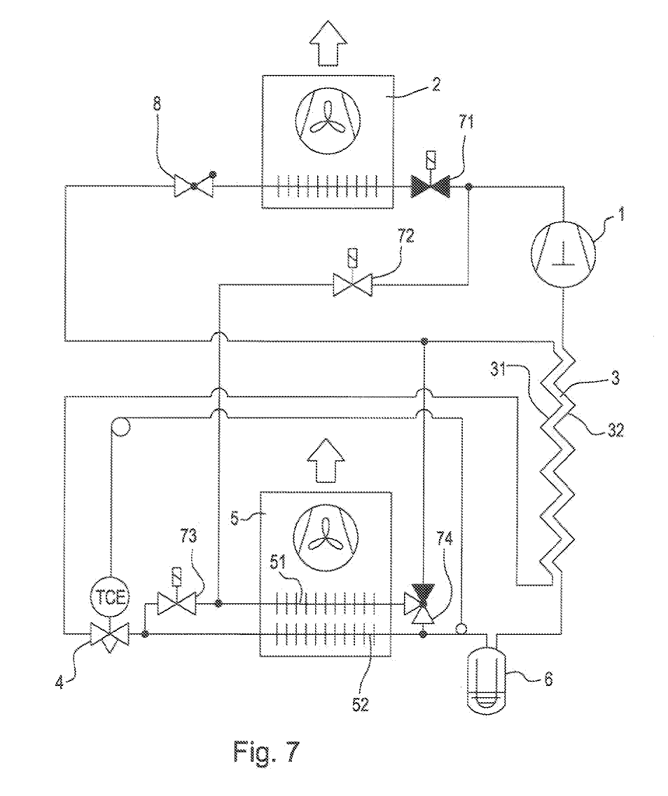

In FIG. 7, the “maximum heating” mode is shown. The refrigerant is compressed by the compressor 1 to high pressure and flows via the valve 72, the inner heat exchanger 5, the collector 6, and the low-pressure part 32 of the inner heat exchanger 3 back to the compressor 1. A part of the refrigerant flows via the sub-branch 51 of the inner heat exchanger 5 and the three-way valve 74 to the collector 6, and another part flows in parallel via the valve 73 and the sub-branch 52 of the inner heat exchanger 5. The valve 71 remains closed in tills operating mode and blocks the outer heat exchanger 2 and the high-pressure part 31 of the inner heat exchanger 3. The refrigerant can expand from high pressure to low pressure, e.g., through the pulsed opening and closing of the valve 72.

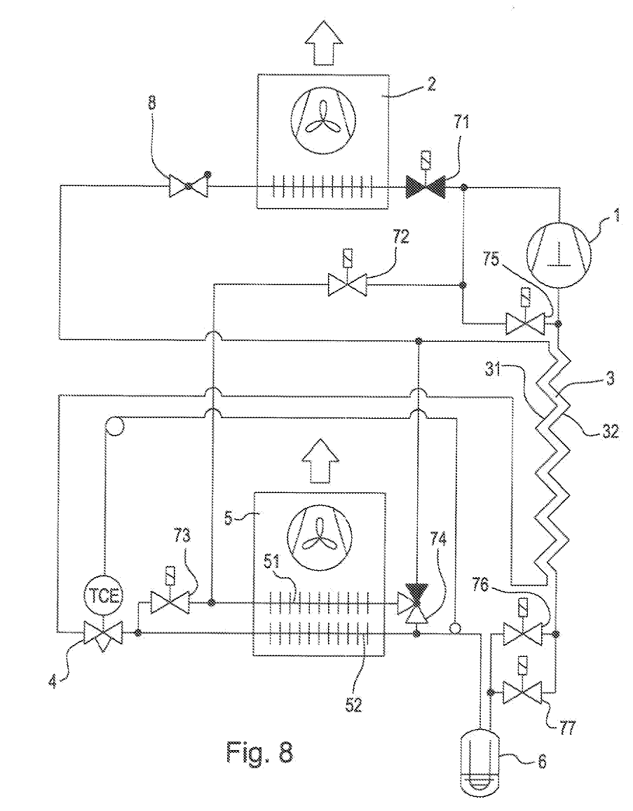

In FIG. 8, a bypass between the high-pressure side and the low-pressure side of the compressor 1, circumventing the outer heat exchanger 2 and the inner heat exchanger 5, is also described. It can be blocked by means of fee valve 75. The opening of the valve 75 can be used for regulating a defined suction-gas overheating on the compressor inlet during the hot gas cycle (“maximum heating” or “normal heating”) or also for regulating a defined temperature or pressure level on the compressor. Advantageously, cooling of the compressor by liquid refrigerant on the compressor Inlet is to be prevented.

Furthermore, in FIG. 8 the parallel valves 76 and 77 are arranged in the suction line, here, advantageously at the inlet in the low-pressure part 32 of the inner heat exchanger 3. They could also be arranged directly in front of the compressor 1 or one of the valves in a bypass parallel to the low-pressure part 32 of the inner heat exchanger 3. In the open state, they have no significant pressure loss for the “maximum cooling,” “normal cooling,” “dehumidifying and cooling,” and “dehumidifying and heating” operating modes, In the “normal heating” or “maximum heating” operating modes, they are driven as expansion elements.

Here, the valves can have the same or different throttle characteristic curves, e.g., in a ratio of 1 to 2. For regulating the suction-gas overheating at the Met of the compressor 1 or the compressor discharge temperature or the high pressure, both can be open or one can be closed according to the rotational speed or mass flow of the compressor. The mass flow of an unregulated compressor could also be regulated in this way in all of the operating modes.

One of the valves, e.g., valve 77, can also be replaced by a fixed choke and the regulation realized by opening and closing the other valve 76. If the valve 76 has no significant pressure loss in the completely open state, then the valve 77 can be a thermostatic expansion valve, which controls the suction-gas overheating at the compressor inlet in the “maximum heating” and “normal heating” operating modes. In this way, the valve 76 is then closed, but is open in all of the other operating modes. If the valve 76 can also be driven in order to regulate the suction-gas overheating, the compressor discharge temperature, the high pressure, or the mass Sow by means of opening and closing this valve itself, then the valve 77 and the associated sub-branch can also be eliminated.

1. Air-conditioning system with heating function, wherein the air-conditioning system has a refrigerant circuit with at least one compressor (1), at least one outer heat exchanger (2), at least one expansion element (4), and at least one inner heat exchanger (5), characterized in that the inner heat exchanger is divided in the airflow direction, in that the two partial heat exchangers of the inner heat exchanger (5) can both be operated as refrigerant gas coolers by means of switch elements for heating supply air for a maximum heating demand, and in that the two partial heat exchangers of the inner heat exchanger (5) can be switched in parallel.

2. Air-conditioning system with heating function, wherein the air-conditioning system has a refrigerant circuit with at least one compressor (1), at least one outer heat exchanger (2), at least one expansion element (4), and at least one inner heat, exchanger (5), characterized in that the inner heat exchanger (5) is divided in the airflow direction and the first partial heat exchangers (52) of the inner heat exchanger (5) in the airflow direction can be operated by means of switch elements as a refrigerant evaporator for cooling supply air, and in that the second partial heat exchanger (51) of the inner heat exchanger (5) connected downstream in the air direction can be operated as a refrigerant gas cooler for heating supply air.

3. Air-conditioning system according to claim 1 or 2, characterized in that the two partial heat exchangers of the inner heat exchanger (5) can both be operated as refrigerant evaporators by means of switching elements for cooling the supply air for a maximum cooling demand.

4. Air-conditioning system with heating function, wherein the air-conditioning system has a refrigerant circuit with at least one compressor (1), at least one outer heat exchanger (2), at least one expansion element (4), and at least one inner heat exchanger (5), characterized in that the inner heat exchanger (5) is divided in the airflow direction and the first partial heat exchanger (52) of the inner heat exchanger (5) in the airflow direction can be operated as a refrigerant evaporator by means of switching elements in the dehumidifying mode (reheating) and simultaneously the second partial heat exchanger (51) can be operated as a refrigerant gas cooler, by which means the condensation heat of the air moisture can be used advantageously in terms of energy, in addition to the compressor waste heat, for the heating of the supply air.

5. Air-conditioning system with heating function according to claim 4, characterized in that the outer heat exchanger can be operated as a refrigerant gas cooler in parallel with the second partial heat exchanger (51) of the inner heat exchanger (5), in order to discharge excessive heat.

6. Air-conditioning system with heating function according to claim 5, characterized in that the ratio of heat transfer via a partial heat exchanger (51) of the inner heat exchanger (5) and the outer heat exchanger (2) can be regulated and/or controlled nearly continuously by opening and closing the valves (71) and/or (72), by which means, in particular, the supply air blow temperature can be regulated.

7. Air-conditioning system with heating function according to one of claims 1-6, characterized in that the efficiency of the “reheating” mode relative to “reheating” with engine cooling water heat is advantageously increased more in the “dehumidifying and cooling” mode due to the lower temperature in a partial heat exchanger (51) of the inner heat exchanger (5), which can be operated at least proportionally as a refrigerant gas cooler, than in the outer heat exchanger (2), which can also be operated as a refrigerant gas cooler.

8. Air-conditioning system with heating function, according to one of claims 1-7, characterized in that, in the “normal heating” and/or “maximum heating” mode, a valve (72) arranged between the compressor and an inner heat exchanger can be controlled in such a way that a predetermined or sufficient pressure difference between the high pressure and the low pressure on the compressor (1), and thus a predetermined or sufficient compressor operation, can be achieved—in particular, fee compressor waste heat necessary for heating—by which means the valve (72) operates, in particular, as an expansion element.

9. Air-conditioning system with heating function according to one of claims 1-7, characterized in that, in the “normal heating” and/or “maximum heating” mode, a valve (72) arranged between the compressor and an inner heat exchanger can be controlled in such a way that a predetermined and, in particular, a sufficient high pressure on the compressor outlet and thus a predetermined or sufficient compressor operation, can be achieved—in particular, the compressor waste heat necessary for heating—by which means the valve (72) operates, in particular, as an expansion element.

10. Air-conditioning system with heating function according to one of claims 1-7, characterized in that, in the “normal heating” and/or “maximum heating” mode, a valve (72) arranged between the compressor and an inner heat exchanger can be controlled in such a way that a predetermined or sufficient temperature on the compressor outlet, and thus a predetermined or sufficient compressor operation, can be achieved—in particular, the compressor waste heat necessary for heating—by which means the valve (72) operates, in particular, as an expansion element.

11. Air-conditioning system with heating function according to one of claims 1-7, characterized in that, in the “normal heating” and/or “maximum heating” mode, a valve (72) arranged between the compressor and an inner heat exchanger can be controlled in such a way that a predetermined or sufficient suction-gas overheating on the compressor outlet, and thus a predetermined or sufficient compressor operation, can be achieved—in particular, the compressor waste heat necessary for heating—by which means the valve (72) operates, in particular, as an expansion element.

12. Air-conditioning system with heating function according to one of claims 1-11, characterized in that there is a bypass from the compressor outlet via a valve (75) to the compressor inlet, circumventing the outer heat exchanger (2) and an inner heat exchanger (5), and in that the valve (75) is open until a predetermined or sufficient temperature and pressure level can be achieved on the compressor (1), by which means, in particular, a suction-gas overheating can be realized.

13. Air-conditioning system, with heating function according to claim 12, characterized in that, in the “normal heating” or “maximum heating” mode, a valve (75) arranged in a bypass between the compressor inlet and the compressor outlet can be driven in such a way that a predetermined or sufficient suction-gas overheating on the compressor inlet and thus a predetermined or sufficient compressor operation, can be achieved—in particular, the compressor waste heat necessary for healing.

14. Air-conditioning system with heating function according to one of claims 1-13, characterized in that, in a suction line, two valves (76, 77) arranged in parallel are provided, which can be operated as expansion elements in the “normal heating” or “maximum heating” mode and which have no significant pressure loss in the open state In other operating modes.

15. Air-conditioning system with heating function according to claim 14, characterized, in that one of the valves, in particular, the valve (76), has a valve that can be blocked and the other valve (77) has a thermostatic expansion element, and in that in the “normal heating” or “maximum heating” mode, the one waive (76) is closed and the other valve (77) controls a predetermined or sufficient suction-gas overheating at the compressor inlet, and thus a predetermined or sufficient compressor operation—in particular, the compressor heat waste necessary for heating—can be achieved.

16. Air-conditioning system with heating function according to claim 14, characterized in that one of the valves, in particular, the valve (76), has a magnetic valve and the other valve (77) has a fixed choke, and in that in the “normal heating” or “maximum heating” mode, the valve (76) can be driven, so that a predetermined or sufficient high pressure at the compressor outlet and thus a predetermined or sufficient compressor operation—in particular, the compressor waste heat necessary for heating—can be achieved.

17. Air-conditioning system with heating function according to claim 14, characterized in that one of the valves, in particular, the valve (76), has a solenoid, and the other valve (77) a fixed choke, and in that in the “normal heating” or “maximum heating” mode, the valve (76) can be driven so that a predetermined or sufficient temperature at the compressor outlet, and thus a predetermined or sufficient compressor operation—in particular, the compressor waste heat necessary for heating—can be achieved.

18. Air-conditioning system with heating function according to claim 14, characterized in that one of the valves, in particular, the valve (76), has a solenoid, and the other valve (77) a fixed choke, and in that in the “normal heating” or “maximum heating” mode, the valve (76) can be driven so that a predetermined or sufficient suction-gas overheating at the compressor outlet, and thus a predetermined or sufficient compressor operation—in particular, the compressor waste heat necessary for heating—can be achieved.

19. Air-conditioning system with heating function according to claim 14, characterized in that both valves (76, 77) have controllable valves, with which choke cross sections that differ relative to each other in ratio can be opened, for example, in a ratio of 1:2, and in that the valves can be controlled in such a way that the high pressure or the temperature on the compressor outlet or the suction-gas overheating or the suction pressure or the suction-gas density can be regulated on the compressor inlet or the mass flow of the—especially unregulated—compressor (1) to certain predetermined values.

20. Air-conditioning system with heating function according to one of claims 1-19, characterized in that advantageously, the “maximum cooling,” “normal cooling,” and “dehumidifying and cooling” operating modes can be selected one after the other for the cooling of the vehicle interior as a function of the difference between the desired value and actual value of the temperature to be regulated.

21. Air-conditioning system with heating function according to one of claims 1-20, characterized in that the “maximum heating,” “normal heating,” or “dehumidifying and heating” operating modes can be selected for the heating of the vehicle interior as a function of the difference between the desired and actual values of the temperature to be regulated, and in that the “maximum heating” mode is provided not immediately after the operation of the partial heat exchanger (52) as an evaporator, which can be achieved, in particular, by a memory storage device in the controller and a blocking of a valve (73) connected before the partial heat exchanger (52).

22. Air-conditioning system with heating function according to claim 21, characterized in that the “maximum heating” and “normal heating” operating modes can be replaced fey heating with engine cooling water for the heating of the vehicle interior after a predetermined engine cooling water temperature has been reached.

23. Air-conditioning system with heating function according to one of claims 1-22, characterized in that CO₂ is provided as the refrigerant.
